(19) United States
(12) Patent Application Publication
(10) Pub. No.: US 2020/0344993 A1
(43) Pub. Date: Nov. 5, 2020

(54) INSECT CATCHING TOOL

(71) Applicant: Car-boy Co.,Ltd., Chiba (JP)

(72) Inventor: Kazuo MAWARIMOTO, Chiba (JP)

(21) Appl. No.: 16/932,330

(22) Filed: Jul. 17, 2020

Related U.S. Application Data
(63) Continuation of application No. PCT/JP2019/001458, filed on Jan. 18, 2019.

(30) Foreign Application Priority Data
Jan. 22, 2018 (JP) 2018-007833

(51) Int. Cl. A01M 3/02; A01M 3/04; B25G 1/04

(52) U.S. Cl. CPC A01M 3/022; B25G 1/04; A01M 3/04

(57) ABSTRACT

An insect catching tool includes a holder that holds an insect catcher sheet. The holder includes a holding plate to be on a surface of the insect catcher sheet, a grip holding the holding plate, and a clamp that holds the insect catcher sheet. The clamp has a handle including a hook to be hooked. With the grip held with one hand, the insect pest caught on the insect catcher sheet can be easily disposed of into a garbage bin simply by hooking and pressing the hook on the handle against an edge of the garbage bin.

### CROSS-REFERENCE TO RELATED APPLICATIONS

This application is a continuation application of International Patent Application No. PCT/JP2019/001458 filed on Jan. 18, 2019, which claims priority to Japanese Patent Application No. 2018-007833 filed on Jan. 22, 2018, the entire contents of which are incorporated by reference.

### BACKGROUND OF INVENTION

### Field of the Invention

The present invention relates to an insect catching tool for catching insect pests infesting a house, such as cockroaches and centipedes.

### Background Art

Insect pests infesting ordinary houses typically include German cockroaches and smokybrown cockroaches. Many other insects, such as centipedes, millipedes, moths, pentatomids, and geckos, are now increasingly infesting houses as global warming and other problems increase. In the near future, highly venomous insect pests, such as hornets, redback spiders, and red imported fire ants, may also infest houses and cause damage.

Once such insect pests are found, they are typically exterminated by applying a spray insecticide or by smashing with a fly swatter. However, spray insecticides are not fast-acting and may allow an insect pest to quickly move to behind a closet or into a narrow space between pieces of furniture, failing to provide satisfactory effects. Smashing with a fly swatter may allow an insect pest to escape when the smashing is weak, or may crush the body of the insect when the smashing is strong, thus scattering the body fluid or parts around. This is unpleasant as well as troublesome to clean up the site stained with the fluid and to dispose of the insect remains.

The inventor has developed a new insect catching tool such as one described in Patent Literature 1. This insect catching tool includes a plate and a pressing member attached to an end of a handle with a length of about 30 cm. A soft insect-catcher sheet having an adhesive surface is attached between the plate and the pressing member. To catch an insect pest such as a cockroach with the catching tool, the user grips the handle with one hand, peels a release liner from the adhesive surface on the insect catcher sheet, places the adhesive surface over the cockroach as with a fly swatter, and traps the cockroach on the insect catcher sheet by adhesion.

With the cockroach being caught on the adhesive surface, the insect catcher sheet may be folded into two to wrap the cockroach inside, just like a Japanese Kashiwamochi sweet wrapped in a Kashiwa leaf, by, for example, pressing a distal portion of a non-adhesive surface on the insect catcher sheet against the floor surface. The cockroach in this state, together with the insect catcher sheet, can then be thrown into a garbage bin and can be disposed of smoothly.

### CITATION LIST

### Patent Literature

Patent Literature 1: Japanese Registered Utility Model No. 3006115

### SUMMARY OF INVENTION

### Technical Problem

When the insect pest caught is thrown into a garbage bin together with the insect catcher sheet with the known insect catching tool described above, the insect catcher sheet is to be detached from a holder by gripping a bar in a lower holder holding the insect catcher sheet and separating the pressing member from the plate in an upper holder. This task is done with both hands, one gripping the handle in the upper holder and the other gripping the bar in the lower holder, and can be troublesome and cause unpleasant, close exposure to the insect pest during the task.

In response to the above issue, one or more aspects of the present invention are directed to a new insect catching tool that allows an insect pest caught to be disposed of easily with one hand.

### Solution to Problem

An insect catching tool according to a first aspect of the present invention includes an insect catcher sheet including a sheet body having a first surface including an adhesive layer and being a soft sheet, and a holder that holds the insect catcher sheet. The holder includes a holding plate to be on a second surface of the insect catcher sheet, a clamp that holds the insect catcher sheet on the holding plate, and a grip extending from the holding plate. The clamp includes a clamp body that presses the insect catcher sheet onto the holding plate to hold the insect catcher sheet, and a bar-shaped handle that causes the clamp body to perform an open or close operation. The handle includes a hook to be hooked.

For example, with the grip held with one hand, the insect catching tool with the above structure is placed to have the insect catcher sheet catching an insect pest facing the inside of a garbage bin, and the hook on the handle of the clamp is then hooked and pressed against the garbage bin edge to open the clamp body and release the insect catcher sheet, which then naturally drops into the garbage bin. Thus, the insect pest caught can be easily disposed of with one hand, unlike in a known manner using both hands. Also, the disposal is free from close exposure to every insect pest being caught and is less unpleasant.

An insect catching tool according to a second aspect of the present invention is the insect catching tool according to the first aspect in which the grip includes a plurality of tubes arranged telescopically to one another. With this structure, the grip is extended as appropriate to allow the insect catcher sheet to access areas that are difficult to reach, such as ceilings and spaces behind objects. An insect pest in such areas may be easily caught. Although the grip is extended to increase the distance between the gripping hand and the insect catcher sheet catching an insect pest, the insect pest caught can be disposed of in this state as described above, without changing the gripping hand to the other.

### Advantageous Effects

With the grip held with one hand, the insect catching tool according to one or more aspects of the present invention is placed to have the insect catcher sheet catching an insect pest facing the inside of a garbage bin, and then the hook on the handle of the clamp is hooked and pressed against the garbage bin edge to open the clamp body and release the insect catcher sheet, which then naturally drops into the garbage bin. The insect pest caught can thus be easily disposed of with one hand, unlike in a known manner using both hands. Also, the disposal is free from close exposure to every insect pest being caught and is less unpleasant.

### BRIEF DESCRIPTION OF THE DRAWINGS

FIG. 1 is a perspective view of an insect catching tool 100 according to an embodiment of the present invention.

FIG. 2 is a side view of the insect catching tool 100 according to the embodiment of the present invention.

FIG. 3 is a bottom view of the insect catching tool 100 according to the embodiment of the present invention.

FIG. 4 includes bottom views of an insect catcher sheet 10 and a holding plate 21 to which the insect catcher sheet 10 is attachable.

FIG. 5 is a side view of the insect catcher sheet 10, showing a portion of the insect catcher sheet 10 in an enlarged manner.

FIG. 6 is a schematic diagram describing an operation of the insect catcher sheet 10.

FIG. 7 is a perspective view of a clamp 22.

FIG. 8 shows plan and side views of the clamp 22. (A) is a plan view of the clamp 22, and (B) is a side view of the clamp 22.

FIG. 9 shows side views of the clamp 22 in two different states. (A) is a side view of the clamp 22 that is open, and (B) is a side view of the clamp 22 that is closed.

FIG. 10 is a side view of a grip 23 in a holder 20 in an extended state.

FIG. 11 is a schematic diagram describing an example manner of using the insect catching tool 100 according to the embodiment of the present invention.

FIG. 12 is a schematic diagram describing an operation of the insect catching tool 100 according to the embodiment of the present invention.

FIG. 13 is a schematic diagram describing an example manner of using the insect catching tool 100 according to the embodiment of the present invention.

### DETAILED DESCRIPTION

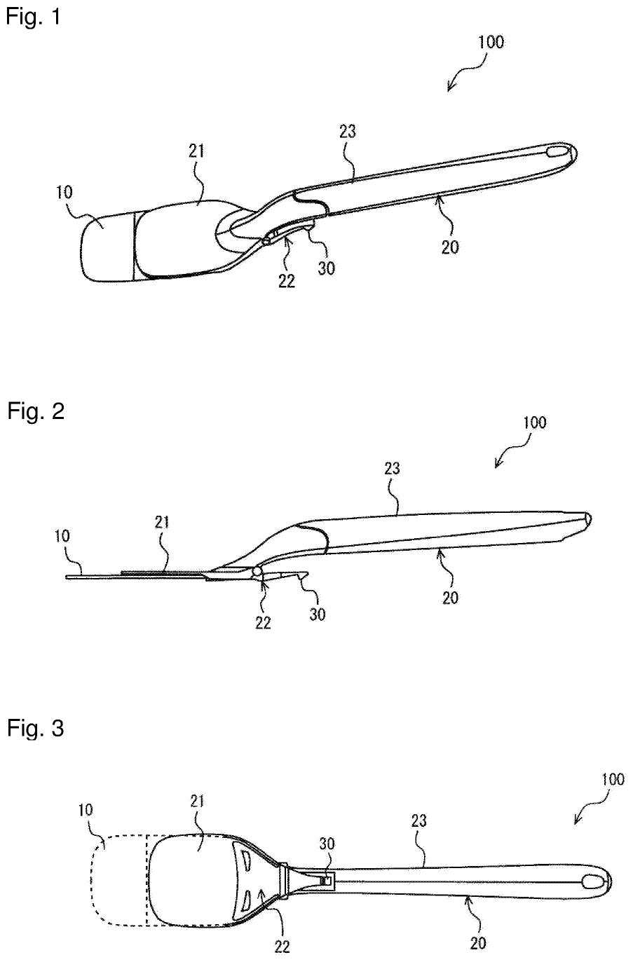

One or more embodiments of the present invention will now be described with reference to the accompanying drawings. FIGS. 1 to 3 are views of an insect catching tool 100 according to an embodiment of the present invention. FIG. 1 is a perspective view, FIG. 2 is a side view, and FIG. 3 is a bottom view. As illustrated, the insect catching tool 100 includes an insect catcher sheet 10 and a holder 20 holding the insect catcher sheet 10.

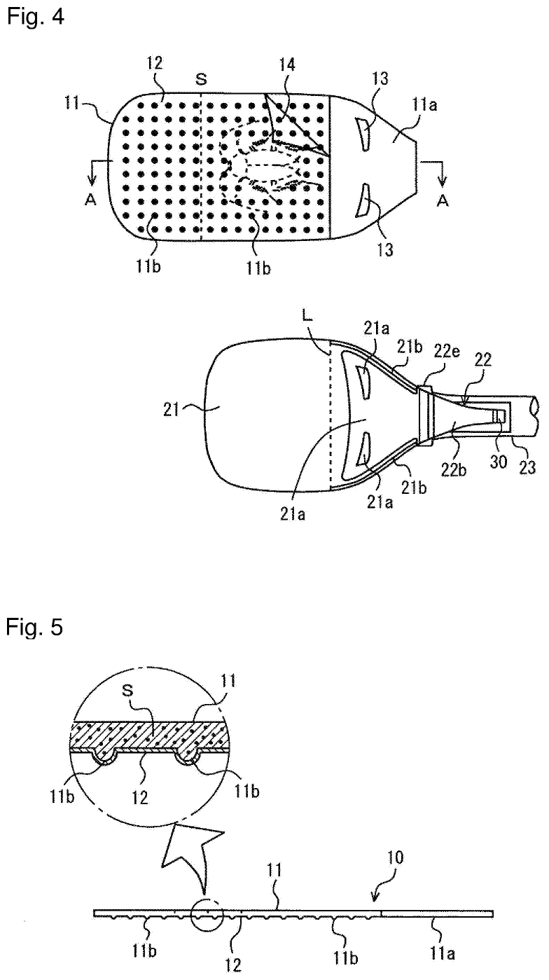

As illustrated, the insect catcher sheet 10 in use is detachably attached to an end of the holder 20. The insect catcher sheet 10 has the structure shown in FIGS. 4 and 5. More specifically, the insect catcher sheet 10 includes, for example, a substantially rectangular sheet body 11 with a length of about 10 to 20 cm, a width of about 5 to 15 cm, and a thickness of about 2 to 5 mm, and an adhesive layer (adhesive surface) 12 on one surface of the sheet body 11. The sheet body 11 is formed from a soft resin, such as polyurethane or foamed polyethylene, or other flexible materials, such as paper. The sheet body 11 is foldable in two along a predetermined line described later.

The adhesive layer (adhesive surface) 12 is formed from a rubber adhesive or an acrylic adhesive. As shown in FIG. 4, the adhesive layer (adhesive surface) 12 is located on the entire surface of the sheet body 11 excluding an attachment portion 11a at an end of the sheet body 11. The attachment portion 11a has a pair of attachment holes 13 in a width direction. The attachment holes 13 are used to attach a holding plate 21 (described later) in the holder 20. As shown in FIGS. 4 and 5, the surface of the sheet body 11 receiving the adhesive layer 12 is embossed. For example, the surface has a lattice of minute protruding dots 11b with a height of about 0.5 to 1.0 mm arranged at intervals of 5 to 10 mm.

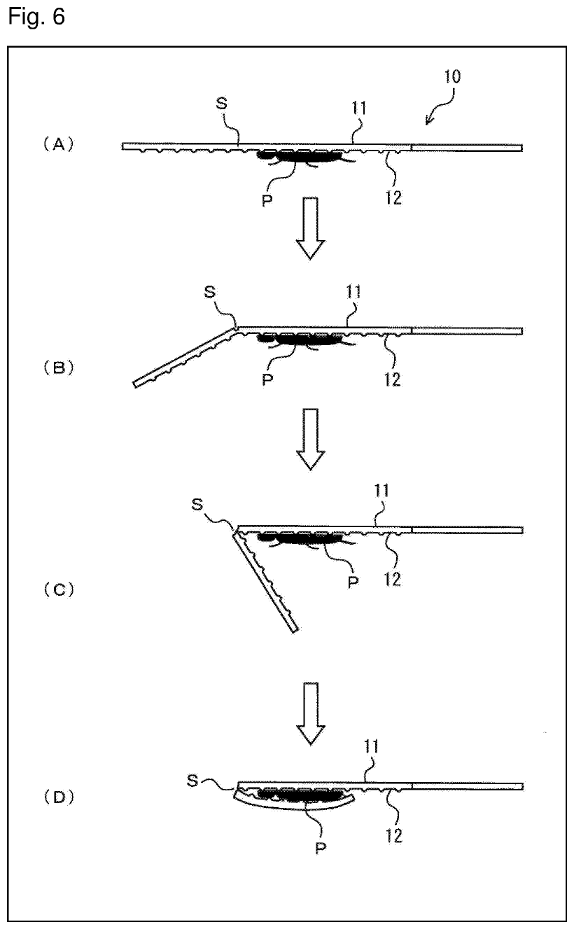

A surface of the sheet body 11 opposite to the adhesive layer 12 has a slit S extending in the width direction. As shown in FIG. 6, the sheet body 11 is foldable in two along the slit S with the adhesive layer 12 inside. As shown in FIG. 4, the adhesive layer 12 on the sheet body 11 is covered with a release liner 14, which is peeled to uncover the adhesive layer 12.

As shown in FIGS. 1 to 3, the holder 20 includes a holding plate 21 to be located on the upper surface (non-adhesive surface) of the insect catcher sheet 10, a clamp 22 to hold the insect catcher sheet 10 on the holding plate 21, and a grip 23 extending from the clamp 22. As shown in FIGS. 1 to 4, the holding plate 21 is a thin, spatula-shaped plate with a distal end expanding in an oval like a rice paddle. The insect catcher sheet 10 is to be attached to the inner (bottom) surface of the holding plate 21.

More specifically, as shown in FIG. 4, the holding plate 21 has, on its lower surface, a pair of protrusions 21a in a narrow portion at an end of the lower surface (adjacent to the grip 23). The pair of protrusions 21a correspond to the pair of attachment holes 13 in the attachment portion 11a of the sheet body 11. The holding plate 21 also has guides 21b to be aligned with the outer edge of the attachment portion 11a. The protrusions 21a are fitted in the attachment holes 13 in the sheet body 11 to attach the insect catcher sheet 10 to the lower surface of the holding plate 21 as shown in FIG. 3.

The holding plate 21 has its entire body or at least its flat distal end portion, such as a portion from a line L to the distal end shown in FIG. 4, formed from a flexible resin material, such as rubber (elastomer), polyvinyl chloride (PVC) commonly referred to as soft rubber, polyethylene, and polypropylene. The flexible holding plate 21 is thus deformable and recoverable under an appropriate force.

As shown in FIGS. 4, 7, and 8, the clamp 22 includes a fan-shaped clamp body 22a, a bar-shaped handle 22b extending from the clamp body 22a, shaft holes 22c at the joint between the clamp body 22a and the handle 22b, a coil spring 22d, and divided pins 22e for connection.

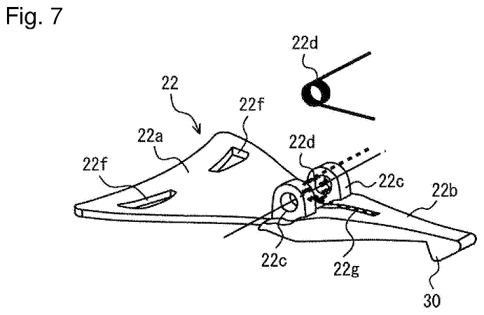

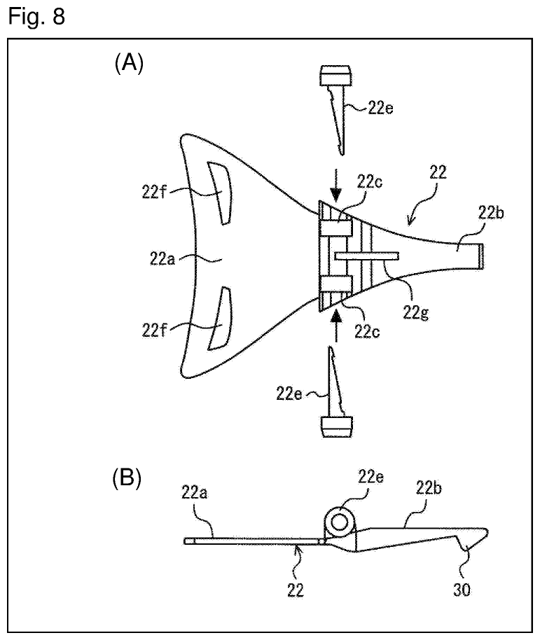

As shown in FIG. 7, with the coil spring 22d having one end fitted in a spring groove 22g on the handle 22b, the shaft holes 22c are aligned coaxially with shaft holes (not shown) in the holding plate 21. As shown in FIG. 8, the divided pins 22e are placed through the shaft holes 22c through both ends of the shaft holes 22c and connected together into one piece. The clamp 22 is thus attached in a manner vertically swingable about the divided pins 22e serving as a shaft.

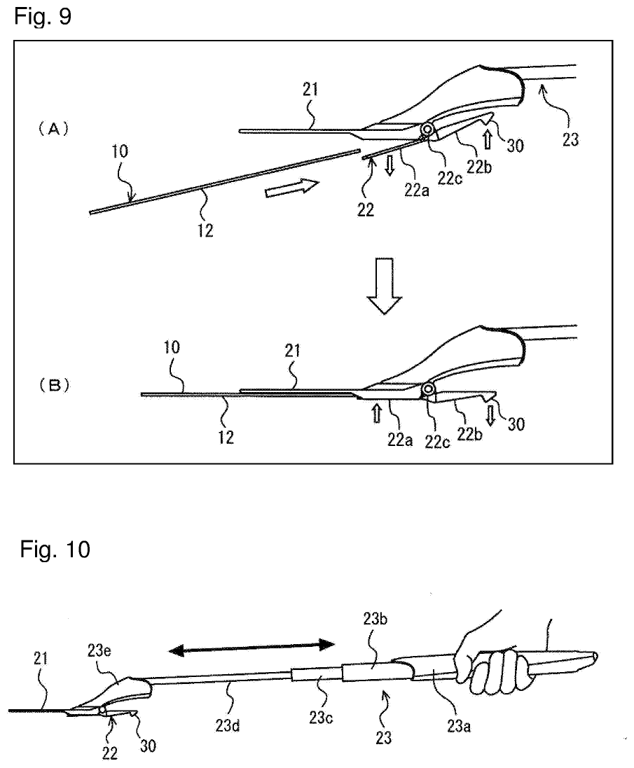

The clamp 22 attached to the holding plate 21 in the above manner has the coil spring 22d located at the shaft urging the fan-shaped clamp body 22a closely against the lower surface of the holding plate 21. As the handle 22b is moved toward the grip 23 by fingers as shown in FIG. 9, the entire clamp 22 swings to separate the clamp body 22a from the holding plate 21. When the handle 22b is released, the urging force from the coil spring 22d automatically restores the clamp body 22a to an original position (open or close operation).

As shown in FIGS. 7 and 8, the handle 22b of the clamp 22 has a hook 30 at the tip end. The hook 30 has a substantially triangular cross section and protrudes downward. As shown in FIGS. 7 and 8, the clamp body 22a of the clamp 22 has fitting holes 22f similar to the attachment holes 13 in the insect catcher sheet 10. When the clamp body 22a is in close contact with the lower surface of the holding plate 21, the fitting holes 22f are fitted with the protrusions 21a on the holding plate 21, without any interference between the clamp body 22a and the holding plate 21.

As shown in FIG. 10, the grip 23 includes multiple tubes arranged telescopically to one another. More specifically, the grip 23 includes a hollow grip body 23a for direct gripping by a hand as illustrated, a first inner tube 23b retractable in the grip body 23a, a second inner tube 23c retractable in the first inner tube 23b, and a third inner tube 23d retractable in the second inner tube 23c.

The third inner tube 23d has the distal end integrally connected to the holding plate 21 with a grip head 23e extending from the upper end surface of the holding plate 21. The grip body 23a, the first inner tube 23b, the second inner tube 23c, and the third inner tube 23d each have a length of, for example, about 20 cm. The grip body 23a, the first inner tube 23b, the second inner tube 23c, and the third inner tube 23d together have a maximum length of 60 to 80 cm when extended, and together have a minimum length equal to the length of the grip body 23a or specifically about 20 cm when contracted. Thus, the total length of the grip 23 can be adjusted within about 20 to 80 cm by adjusting the extensions of the first inner tube 23b, the second inner tube 23c, and the third inner tube 23d retracted in the grip body 23a.

An operation of the insect catching tool 100 according to one or more embodiments of the present invention with the above structure will now be described. When finding an insect pest on a floor or wall of a room, a resident first raises the handle 22b of the clamp 22 as shown in FIG. 9 and sets the insect catcher sheet 10 on the lower surface of the holding plate 21 with the adhesive surface 12 facing downward. The resident then releases the handle 22b of the clamp 22, allowing the clamp 22 and the holding plate 21 to hold the insect catcher sheet 10 between them. As shown in FIG. 10, the resident may also adjust the grip 23 to an appropriate length by pulling out the first inner tube 23b or other tubes.

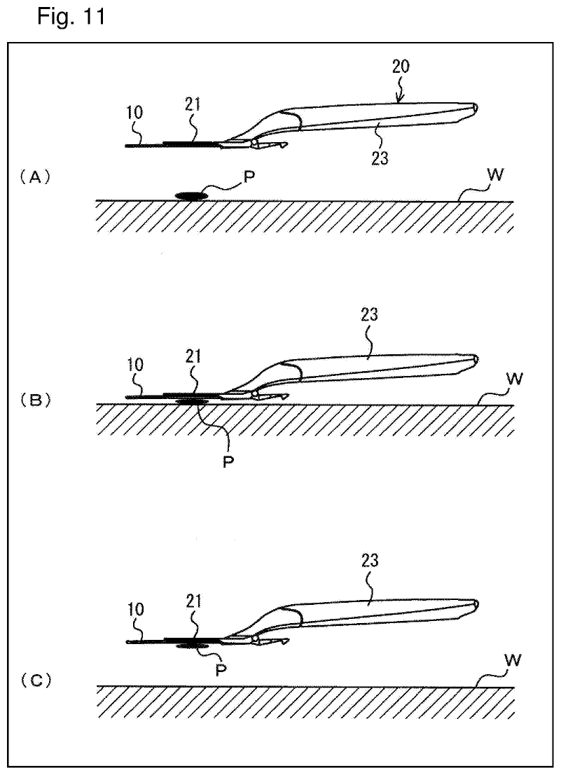

As shown in FIGS. 11(A) and 11(B), the grip body 23a of the grip 23 is then held with a hand. The insect catcher sheet 10 is placed over an insect pest P as with a fly swatter, and the holding plate 21 is quickly slammed down onto a floor or wall W. The insect pest P on the floor or wall W then adheres to the adhesive surface 12 on the insect catcher sheet 10 almost immovably and is thus trapped. In the figures, the grip 23 is at a minimum length for ease of illustration.

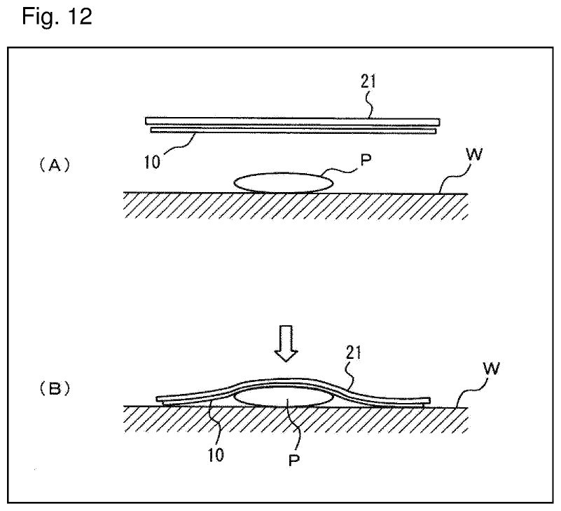

At the moment of trapping the insect pest P, as shown in FIG. 12, the flexible holding plate 21 bends with the insect catcher sheet 10 and deforms into close contact with the outer surface of the insect pest P. This increases the area of contact between the adhesive surface 12 on the insect catcher sheet 10 and the insect pest P, reliably trapping the insect pest P on the adhesive surface 12 by adhesion.

The grip 23, which includes multiple tubes arranged telescopically as described above, may be extended as appropriate to allow the insect catcher sheet 10 to access areas that are difficult to reach, such as ceilings and spaces behind objects. An insect pest P in such areas may be easily trapped.

After trapping the insect pest P on the insect catcher sheet 10 in the above manner, the insect catcher sheet 10 may be separated from the floor or wall W as shown in FIG. 11(C). The insect pest P adhering to the adhesive surface 12 on the insect catcher sheet 10 is thus caught. When a part of the insect catcher sheet 10 around the insect pest P caught on the sheet may come in contact with and adhere to the floor or wall W, the adhesive surface 12 on the insect catcher sheet 10 comes in point contact with the floor or wall W at the protruding dots 11b as described above. The insect catcher sheet 10 can be easily peeled off without firmly clinging to the floor or wall. When failing to trap an insect pest P as well, the insect catcher sheet 10 can avoid having the adhesive surface 12 firmly clinging to the floor or wall W and can be peeled off easily.

For an insect pest P typically having a curved or complexly irregular body surface, the insect catcher sheet 10 simply slammed onto the insect pest P can come in contact with a large surface portion of the insect pest P and cling to the insect pest P not only at the protruding dots 11b but also at flat portions between the protruding dots 11b. Once trapped by adhesion, the insect pest P cannot escape and is caught reliably. The adhesive surface 12 on the insect catcher sheet 10 may not be embossed but may be in any pattern that partially protrudes from a flat surface, such as a lattice, a mesh, and waves, which allows the adhesive surface 12 on the insect catcher sheet 10 to be in point or line contact with the floor or wall W.

With the insect pest P trapped on the adhesive surface on the insect catcher sheet 10 as above, the grip 23 is then operated to press the distal end of the insect catcher sheet 10 against the nearby floor or wall W in the manner shown in FIG. 6. This allows the distal end portion of the sheet body 11 of the insect catcher sheet 10 to bend toward the adhesive surface 12 at the slit S until the sheet body 11 is folded in two. As shown in FIGS. 6(C) and 6(D), the insect pest P trapped on the adhesive surface 12 is thus entirely wrapped in the distal end portion of the bent sheet body 11, completely trapped inside the sheet body 11 without being viewable from outside.

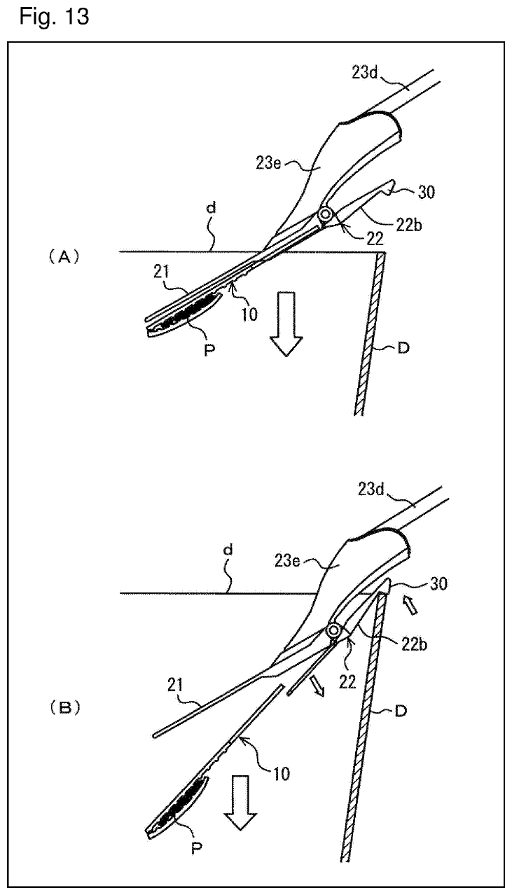

As shown in FIG. 13(A), the insect catcher sheet 10 in this state is moved to, for example, over a garbage bin D. The handle 22b of the clamp 22 is then pressed against the opening edge d of the garbage bin D. The hook 30 at the tip end of the handle 22b is then hooked on the opening edge d of the garbage bin D as shown in FIG. 13(B), causing the clamp 22 to pivot about the divided pins 22e serving as a shaft. The insect catcher sheet 10 wrapping the insect pest P inside then separates (drops) from the holding plate 21 into the garbage bin D.

In this manner, the insect catcher sheet 10 catching an insect pest P can be disposed of in a clean and smooth manner, without causing exposure to or direct viewing of the insect pest P being caught. The insect pest caught can be easily disposed of with one hand, unlike in a known manner using both hands. Also, the disposal is free from close exposure to every insect pest being caught and is less unpleasant or not unpleasant.

The grip 23 may be extended as appropriate to allow the insect catcher sheet 10 to access areas that are difficult to reach, such as ceilings and spaces behind objects. An insect pest in such areas may thus be easily caught. Although the grip 23 is extended to increase the distance between the gripping hand and the insect catcher sheet 10 catching the insect pest P, the insect pest caught can be disposed of in this state as described above, without changing the gripping hand to the other.

### REFERENCE SIGNS LIST

100 insect catching tool
10 insect catcher sheet
11 sheet body
12 adhesive layer (adhesive surface)
20 holder
21 holding plate
22 clamp
23 grip
30 hook
D garbage bin
P insect pest
W floor or wall

1. An insect catching tool, comprising:
an insect catcher sheet including a sheet body having a first surface including an adhesive layer, the insect catcher sheet being a soft sheet; and
a holder configured to hold the insect catcher sheet, the holder including a holding plate to be on a second surface of the insect catcher sheet, a clamp configured to hold the insect catcher sheet on the holding plate, and a grip extending from the holding plate, the clamp including a clamp body configured to press the insect catcher sheet onto the holding plate to hold the insect catcher sheet, and a bar-shaped handle configured to cause the clamp body to perform an open or close operation, the handle including a hook to be hooked.

2. The insect catching tool according to claim 1, wherein
the grip includes a plurality of tubes arranged telescopically to one another.
